(19) United States
(12) Patent Application Publication
(10) Pub. No.: US 2007/0093114 A1
(43) Pub. Date: Apr. 26, 2007

(54) Resilient latching device

(76) Inventors: Yi-Yu Chang, Chung Ho City (TW); Chun-Hsu Chen, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,991

(22) Filed: Oct. 26, 2005

(51) Int. Cl. H01R 13/627

(52) U.S. Cl. 439/357

(57) ABSTRACT

A resilient latching device is mounted on an electrical connector for latching onto a mating connector. The resilient latching device has a mounting portion, a pressing portion, and a latching portion. The mounting portion is fixed on a top face of an insulative housing of the electrical connector. The pressing portion defines a fixing end and a free end at a rear end and a front end thereof, respectively. The fixing end is integrally connected to the mounting portion. The pressing portion forms a bulgy shape corresponding to the top face of the insulative housing. The latching portion is integrally connected to the free end of the pressing portion and extends forward. As a result, the electrical connector can be smoothly separated from the mating connector, and deformation of the latching portion and wear and tear of the insulative housing of the mating connector are avoided.

### BACKGROUND OF THE INVENTION

1. Field of the Invention

The present invention relates to a resilient latching device, and more particularly, to a resilient latching device of an electrical connector.

2. Background of the Invention

There are many different types of electrical connectors and they are commonly used for many types of electronic products. An electrical connector is connected to a mating connector, so that the terminals of the electrical connector are electrically contacted to the terminals of the mating connector. A resilient latching device is provided for being mounted on the electrical connector and latching onto the mating connector to ensure that the mating status between the electrical connector and the mating connector is stable.

A conventional resilient latching device includes a first leg and a second leg. The first leg and the second leg form a V shape. The first leg is fixed on an insulative housing of an electrical connector. The second leg has a first portion, a second portion, and a third portion. The first portion is connected to the first leg and has two protrusions. The second portion is connected between the first portion and the third portion.

When the electrical connector is connected to a mating connector, the protrusions latch onto locking apertures of an insulative housing of the mating connector, so as to ensure that the mating status between the electrical connector and the mating connector is stable.

When the third portion of the second leg is depressed, the protrusions of the first portion of the second leg depart from the locking apertures. As such, the electrical connector is separated from the mating connector.

However, when the third portion of the second leg is depressed, the protrusions of the first portion of the second leg first push against the insulative housing of the mating connector, and then depart from the locking apertures. As a result, the electrical connector is unable to smoothly separate from the mating connector causing the protrusions to be easily deformed, and the insulative housing of the mating connector becomes worn away over time.

### SUMMARY OF INVENTION

The primary object of the invention is therefore to specify a resilient latching device to ensure that the mating status between an electrical connector and a mating connector is stable, to ensure that the electrical connector can be smoothly separated from the mating connector, to prevent the resilient latching device from deforming, and to protect an insulative housing of the mating connector from unnecessary wear and tear.

According to the invention, the object is achieved via a resilient latching device mounted on an electrical connector for latching onto a mating connector. The resilient latching device comprises a mounting portion, a pressing portion, and a latching portion. The mounting portion is fixed on a top face of an insulative housing of the electrical connector. The pressing portion defines a fixing end and a free end at a rear end and a front end thereof, respectively. The fixing end is integrally connected to the mounting portion. The pressing portion forms a bulgy shape corresponding to the top face of the insulative housing. The latching portion is integrally connected to the free end of the pressing portion and extends forward. The latching portion and the top face of the insulative housing form a gap therebetween. The latching portion is moved into the gap when the pressing portion is depressed toward the top face of the insulative housing.

The latching portion latches onto the mating connector, so as to ensure that the mating status between the electrical connector and the mating connector is stable. The latching portion is connected to the free end of the pressing portion and extends forward, so as to ensure that the electrical connector is able to be smoothly separated from the mating connector, to prevent the latching portion from deforming, and to protect the insulative housing of the mating connector from unnecessary wear and tear.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a perspective view of a first embodiment of a resilient latching device of the present invention;

FIG. 2 is a side view of a first embodiment of a resilient latching device of the present invention;

FIG. 3 is an upward view of a first embodiment of a resilient latching device of the present invention;

FIG. 4 is a perspective view of a second embodiment of a resilient latching device of the present invention;

FIG. 5 is a side view of a second embodiment of a resilient latching device of the present invention;

FIG. 6 is a perspective view of a third embodiment of a resilient latching device of the present invention;

FIG. 7 is a side view of a third embodiment of a resilient latching device of the present invention;

FIG. 8 is an upward view of a third embodiment of a resilient latching device of the present invention;

FIG. 9 is a perspective view of a fourth embodiment of a resilient latching device of the present invention; and

FIG. 10 is a side view of a fourth embodiment of a resilient latching device of the present invention.

### DETAILED DESCRIPTION OF THE EMBODIMENTS

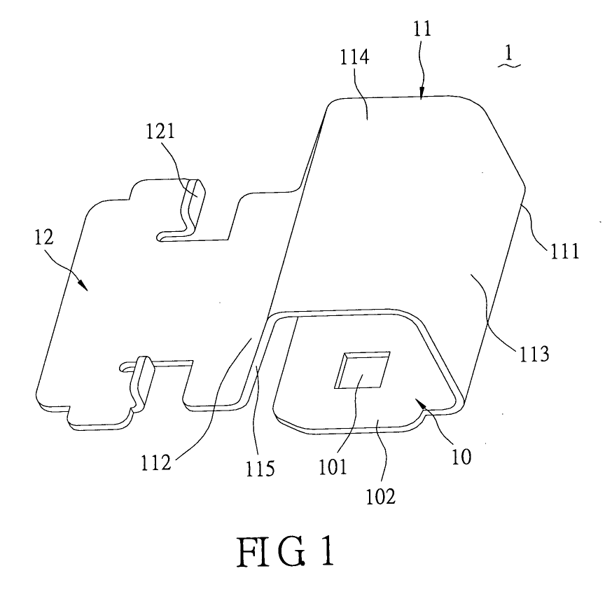

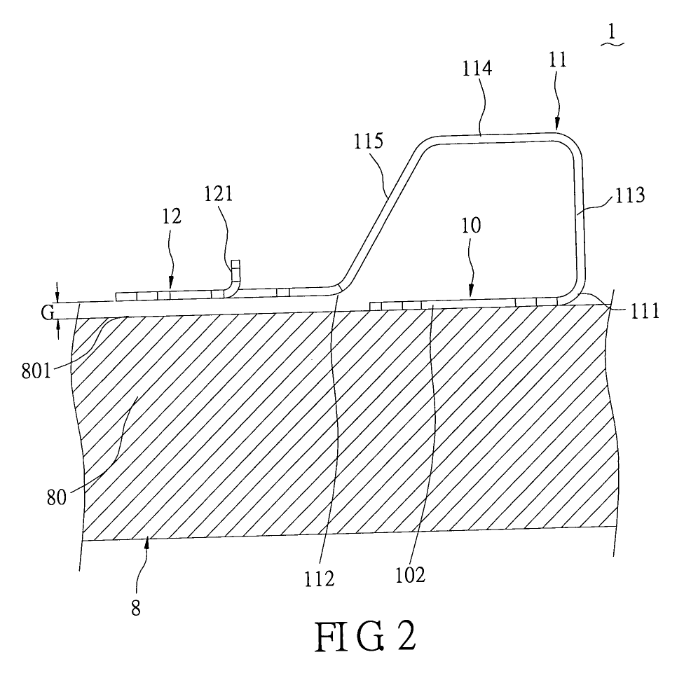

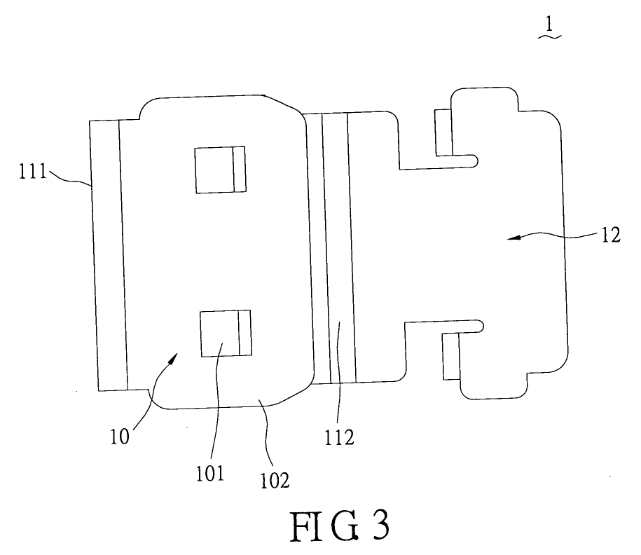

FIGS. 1-3 show a first embodiment of the present invention. The present invention provides a resilient latching device 1 mounted on an electrical connector 8 for latching onto a mating connector (not shown). Each of the electrical connector 8 and the mating connector has an insulative housing and a plurality of terminals received in the insulative housing. The insulative housing 80 of the electrical connector 8 and the insulative housing of the mating connector match each other, so that the terminals (not shown) of the electrical connector 8 and the terminals of the mating connector electrically contact with each other.

The resilient latching device 1 may be formed in one piece from a metal plate and comprises a mounting portion 10, a pressing portion 11, and a latching portion 12.

The mounting portion 10 has a retaining hole 101 and two positioning flanges 102 respectively disposed on two lateral edges thereof. The insulative housing 80 of the electrical connector 8 has a retaining lump (not shown) and two positioning walls (not shown) disposed on a top face 801 thereof. The retaining hole 101 engages with the retaining lump, and the positioning flanges 102 respectively engage with the positioning walls, so that the mounting portion 10 is reliably fixed on the top face 801 of the insulative housing 80 of the electrical connector 8.

The pressing portion 11 defines a fixing end 111 and a free end 112 at a rear end and a front end thereof, respectively. The fixing end 111 is integrally connected to the mounting portion 10, and the pressing portion 11 forms a bulgy shape corresponding to the top face 801 of the insulative housing 80.

In the first embodiment, the pressing portion 11 has a raised portion 113, a horizontal portion 114, and a connecting portion 115. The horizontal portion 114 has a rear end and a front end being respectively connected to a top end of the raised portion 113 and a top end of the connecting portion 115. A bottom end of the raised portion 113 and a bottom end of the connecting portion 115 are respectively connected to the mounting portion 10 and the latching portion 12.

The latching portion 12 is integrally connected to the free end 112 of the pressing portion 11 and extends forward. The latching portion 12 is parallel to the mounting portion 10. The latching portion 12 and the top face 801 of the insulative housing 80 of the electrical connector 8 form a gap G therebetween to facilitate the latching portion's 12 downward movement.

In addition, the latching portion 12 has at least one projection 121 extending upward. In the first embodiment, the latching portion 12 has two projections 121 extending upward, so as to increase the stability when the latching portion 12 latches onto the insulative housing of the mating connector.

When the electrical connector 8 is connected to the mating connector, the projections 121 of the latching portion 12 latch onto locking apertures of the insulative housing of the mating connector to ensure that a mating status between the electrical connector 8 and the mating connector is stable.

When the pressing portion 11 is depressed toward the top face 801 of the insulative housing 80, the latching portion 12 is moved into the gap G. The projections 121 of the latching portion 12 move forward to directly depart from the locking apertures, so that the electrical connector 8 is capable of being separated from the mating connector smoothly. As the projections 121 do not push against the insulative housing of the mating connector, the projections 121 do not deform, and the insulative housing of the mating connector is not worn.

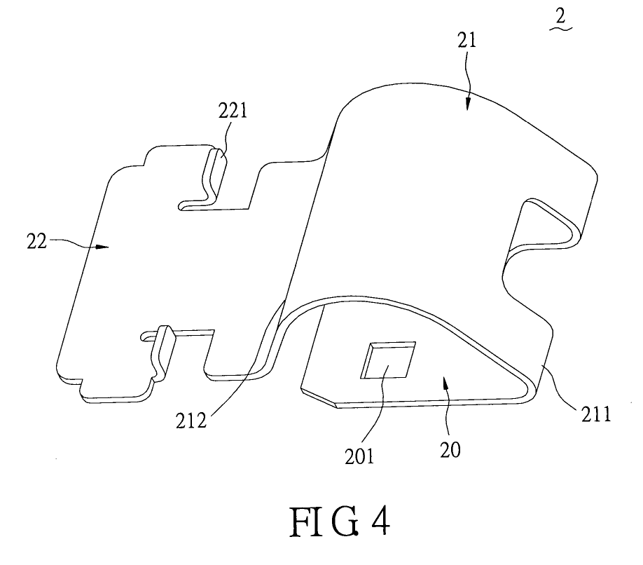

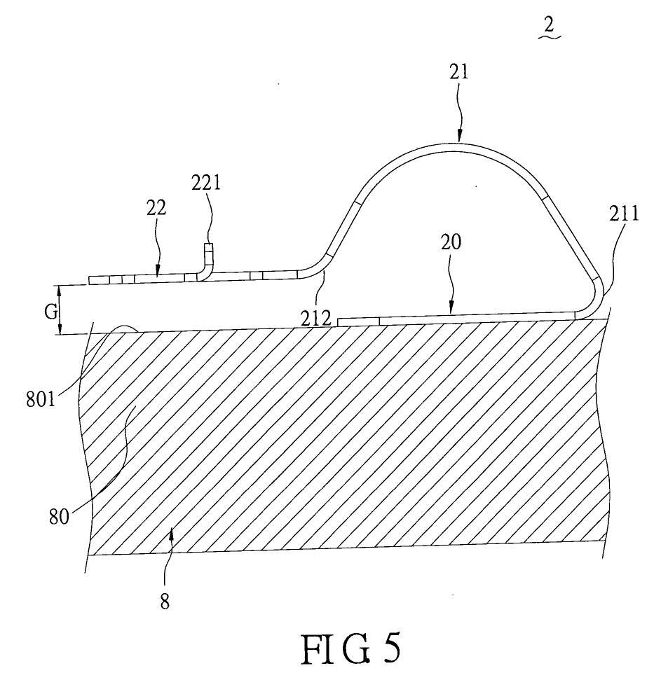

FIGS. 4 and 5 show a second embodiment of the present invention. In the second embodiment, the resilient latching device 2 comprises a mounting portion 20, a pressing portion 21, and a latching portion 22. The fixing end 211 of the pressing portion 21 is integrally connected to the mounting portion 20, and the latching portion 22 is integrally connected to the free end 212 of the pressing portion 21. The mounting portion 20 has a retaining hole 201. The latching portion 22 has two projections 221. The latching portion 22 and the top face 801 of the insulative housing 80 of the electrical connector 8 form a gap G therebetween. The difference between the second embodiment and the first embodiment is that the pressing portion 21 has a curve-shaped longitudinal cross-section.

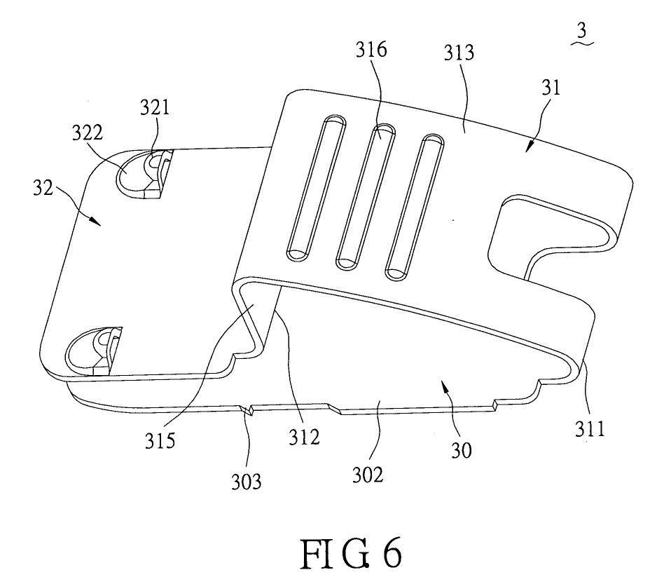

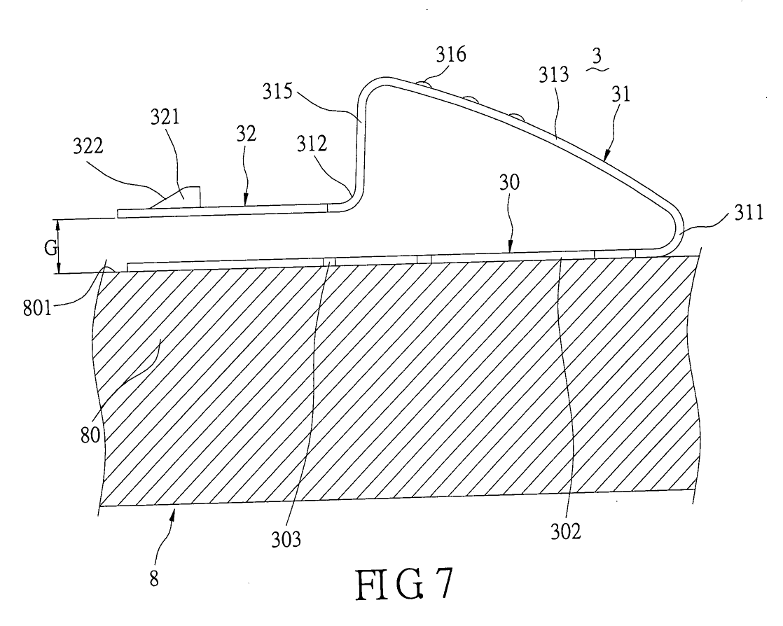

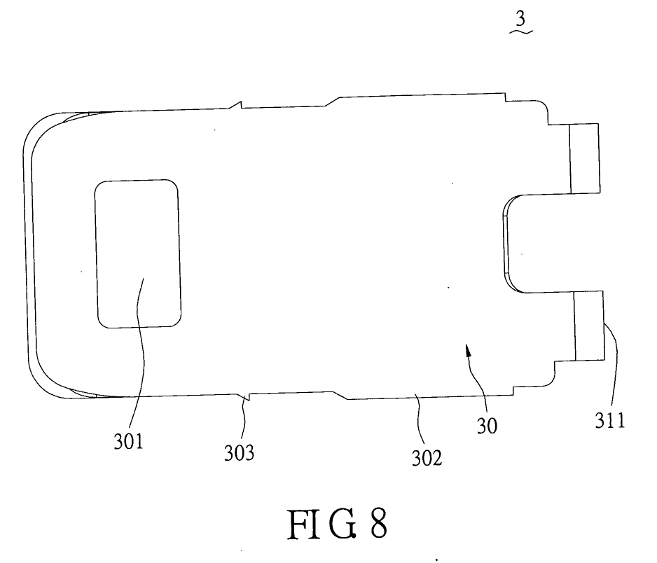

FIGS. 6-8 show a third embodiment of the present invention. In the third embodiment, the resilient latching device 3 comprises a mounting portion 30, a pressing portion 31, and a latching portion 32. The fixing end 311 of the pressing portion 31 is integrally connected to the mounting portion 30, and the latching portion 32 is integrally connected to the free end 312 of the pressing portion 31. The mounting portion 30 has a retaining hole 301 and two positioning flanges 302. The mounting portion 30 extends forward to and under the latching portion 32 and further has two barbs 303 respectively disposed on two lateral edges thereof and embedded in the insulative housing 80 of the electrical connector 8 to improve the retention force of the mounting portion 30.

In the third embodiment, the pressing portion 31 has an inclined portion 313 and a connecting portion 315. The inclined portion 313 has a top end connected to a top end of the connecting portion 315. A bottom end of the inclined portion 313 and a bottom end of the connecting portion 315 are respectively connected to the mounting portion 30 and the latching portion 32. The inclined portion 313 of the pressing portion 31 further has a plurality of protruding lines 316 to facilitate the pressing portion 31 so that it can be depressed easily. The latching portion 32 has at least one projection 321 (see FIG. 6, the latching portion 32 in the third embodiment has two projections 321) extending upward. The at least one projection 321 forms an inclined guiding face 322 facing a front end of the latching portion 32 to facilitate the electrical connector 8 connecting with the mating connector easily. The latching portion 32 and the top face 801 of the insulative housing 80 of the electrical connector 8 form a gap G therebetween.

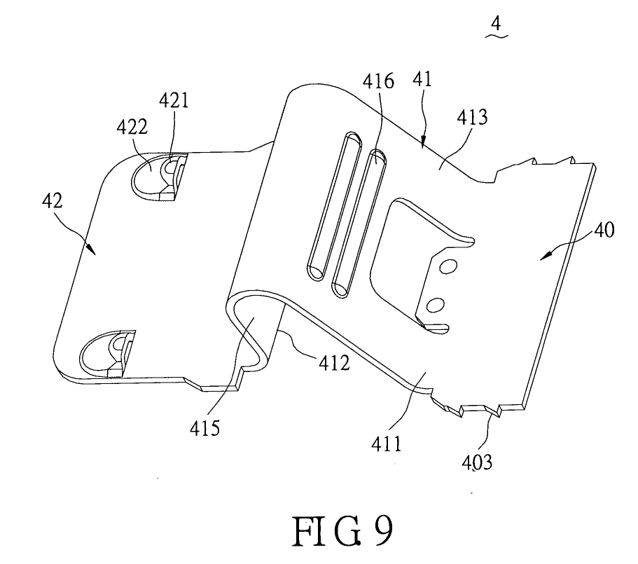

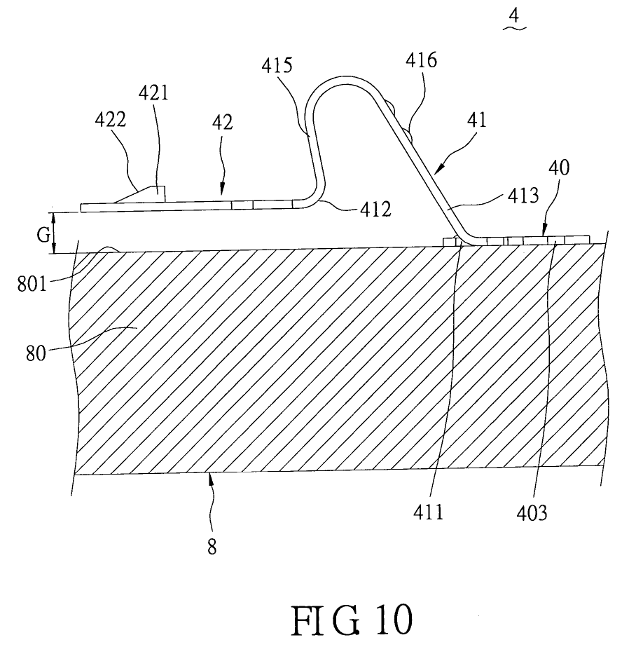

FIGS. 9 and 10 show a fourth embodiment of the present invention. In the fourth embodiment, the resilient latching device 4 comprises a mounting portion 40, a pressing portion 41, and a latching portion 42. The fixing end 411 of the pressing portion 41 is integrally connected to the mounting portion 40, and the latching portion 42 is integrally connected to the free end 412 of the pressing portion 41. The mounting portion 40 extends backward and has at least two barbs 403 respectively disposed on two lateral edges thereof and embedded in the insulative housing 80 of the electrical connector 8. The pressing portion 41 and the latching portion 42 in the fourth embodiment are respectively like the pressing portion 31 and the latching portion 32 in the third embodiment. The pressing portion 41 has an inclined portion 413 and a connecting portion 415. The inclined portion 413 of the pressing portion 41 further has a plurality of protruding lines 416. The latching portion 42 has at least one projection 421 (see FIG. 9, the latching portion 42 in the fourth embodiment has two projections 421) extending upward. The at least one projection 421 forms an inclined guiding face 422 facing a front end of the latching portion 42. The latching portion 42 and the top face 801 of the insulative housing 80 of the electrical connector 8 form a gap G therebetween.

According to the first, second, third and fourth embodiments, the mounting portion may have a different structure to fix on the insulative housing of the electrical connector. The pressing portion may have different bulgy shape corresponding to the top face of the insulative housing of the electrical connector. The projections of the latching portion may have a different structure to latch onto the insulative housing of the mating connector.

As indicated above, the resilient latching device of the present invention has the following advantages:

1. The projections of the latching portion latch onto the locking apertures of the mating connector, so as to ensure that the mating status between the electrical connector and the mating connector is stable.

2. The latching portion is connected to the free end of the pressing portion and extends forward, so that when the pressing portion is depressed, the projections of the latching portion directly depart from the locking apertures of the mating connector, so as to ensure that the electrical connector can be smoothly separated from the mating connector.

3. The projections of the latching portion directly depart from the locking apertures of the mating connector, so as to prevent the latching portion from deforming and to protect the insulative housing of the mating connector from unnecessary wear and tear.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A resilient latching device mounted on an electrical connector for latching onto a mating connector, the resilient latching device comprising:
a mounting portion fixed on a top face of an insulative housing of the electrical connector, wherein the mounting portion includes a planar section having at least one retaining hole passing therethrough, whereby said resilient latching device is mounted to the electrical connector through insert of at least one electrical connector retaining lug member into said at least one of said retaining holes;
a pressing portion defining a fixing end and a free end at a rear end and a front end thereof, respectively, the fixing end being integrally connected to the mounting portion, and the pressing portion forming a bulgy shape corresponding to the top face of the insulative housing; and
a latching portion integrally connected to the free end of the pressing portion and extending forward, the latching portion and the top face of the insulative housing forming a gap therebetween, and the latching portion is moved into the gap when the pressing portion is depressed toward the top face of the insulative housing.

2. (canceled)

3. The resilient latching device as claimed in claim 1, wherein the mounting portion has two positioning flanges respectively disposed on two lateral edges thereof.

4. The resilient latching device as claimed in claim 1, wherein the mounting portion has two barbs respectively disposed on two lateral edges thereof.

5. The resilient latching device as claimed in claim 1, wherein the pressing portion has a raised portion, a horizontal portion, and a connecting portion, the horizontal portion has a rear end and a front end being respectively connected to a top end of the raised portion and a top end of the connecting portion, and a bottom end of the raised portion and a bottom end of the connecting portion are respectively connected to the mounting portion and the latching portion.

6. The resilient latching device as claimed in claim 1, wherein the pressing portion has a curve-shaped longitudinal cross-section.

7. The resilient latching device as claimed in claim 1, wherein the pressing portion has an inclined portion and a connecting portion, the inclined portion has a top end connected to a top end of the connecting portion, and a bottom end of the inclined portion and a bottom end of the connecting portion are respectively connected to the mounting portion and the latching portion.

8. The resilient latching device as claimed in claim 1, wherein the pressing portion has a plurality of protruding lines.

9. The resilient latching device as claimed in claim 1, wherein the latching portion has at least one projection extending upward.

10. The resilient latching device as claimed in claim 9, wherein the at least one projection forms an inclined guiding face facing a front end of the latching portion.

11. The resilient latching device as claimed in claim 1, wherein the latching portion has two projections extending upward.

12. The resilient latching device as claimed in claim 1, wherein the latching portion is parallel to the mounting portion.

13. A resilient latching device mounted on an electrical connector for latching onto a mating connector, the resilient latching device comprising:
a mounting portion fixed on a top face of an insulative housing of the electrical connector, wherein the mounting portion has at least two barbs respectively disposed on two lateral edges thereof, so that the resilient latching device is mounted on the electrical connector via the barbs embedding into the insulative housing of the electrical connector;
a pressing portion defining a fixing end and a free end at a rear end and a front end thereof, respectively, the fixing end being integrally connected to the mounting portion, and the pressing portion forming a bulgy shape corresponding to the top face of the insulative housing; and
a latching portion integrally connected to the free end of the pressing portion and extending forward, the latching portion and the top face of the insulative housing forming a gap therebetween, and the latching portion is moved into the gap when the pressing portion is depressed toward the top face of the insulative housing.
